(19) United States
(12) Patent Application Publication
(10) Pub. No.: US 2011/0272312 A1
(43) Pub. Date: Nov. 10, 2011

(54) Article of and method for forming a generally orthogonal corner arrangement having no external fasteners or protrusions

(76) Inventor: Dale Clifford Kramer, Hammondsport, NY (US)

(21) Appl. No.: 13/103,982

(22) Filed: May 9, 2011

Related U.S. Application Data
(60) Provisional application No. 61/332,794, filed on May 9, 2010.

(51) Int. Cl. B65D 75/04; B65D 5/30; B31B 1/50; B65D 5/66

(52) U.S. Cl. 206/424; 229/126; 493/137

(57) ABSTRACT

A box for holding a book or object having orthogonal corners wherein each corner includes a first surface having a bent ear, a second surface having a fold over flap and a third surface that is formed when the fold over flap of the second surface is folded over the bottom and top edges of the bent ear. The end of the fold over flap has tabs at its end which engage tab receptors which are located in the third surface before it folds over the bottom edge of the bent ear. The tab receptors are cavities which extend only partially through the third surface.

### REFERENCE TO RELATED APPLICATIONS

This patent application claims the benefit of U.S. Provisional Application No. 61332794 filed on May 9, 2010, the disclosure of which is incorporated herein by reference in its entirety.

### BACKGROUND OF THE INVENTION

1. Field of the Invention

The present invention relates generally to boxes having flat surfaces and, more specifically, to the mechanical fixation of three generally flat surfaces of corrugated material or solid core material into a generally orthogonal corner arrangement without external or internal fasteners or protrusions to provide a finished box which has smooth interior and exterior surfaces. The three corner surfaces are defined by cut and crease lines in a generally flat sheet of bendable raw material that has tab receptors for receiving tabs at the end of a fold over flap where the tab receptors are cavities where the material has been partially removed or pushed aside and the cavity does not go all the way through the material. The sheet can have any number of cuts and creases that can be folded to create any number of smooth three dimensional corners.

2. Background of the Invention

Cardboard box designs that are folded from a cut and creased flat blank are numerous and have been produced for a long time. Cardboard boxes that are folded from a flat blank and that do not require external fasteners such as tape, glue or staples, are less numerous.

These boxes are typically made from 1/16 inch thick corrugated or solid core acid free sheet material such as cardboard. The boxes are typically individually dimensioned to fit an enclosed book or object snugly in order to reduce the shelf space necessary for book storage but are also made in standard sizes.

An archival box that has been made for decades for receiving a book is generally referred to as having a clamshell design. The corner fixation in this clamshell design involves a fold over flap that has tabs on its end. When the flap is folded over the bent ear of a second corner surface, the tabs engage receptor holes in the third corner surface. This holds the flap and corner in their final position.

Although the corner is sturdily fixed, the tabs and tab receptor through holes produce a corner with a potentially rough exterior surface with protruding tabs. This rough surface has the potential of damaging the cover of a neighboring un-boxed book when sliding the boxed book on and off the shelf.

For this reason, the prior art box design is not used to selectively box more valuable or damaged books on a shelf.

### SUMMARY OF THE INVENTION

In an exemplary embodiment of the present invention, there is disclosed a box, each corner comprising:
a first surface having a bent ear;
a second surface having a fold over flap; and
a third surface that is formed when the fold over flap of the second surface is folded over the bottom and top edges of the bent ear;
wherein the end of the fold over flap has at least two tabs at its end;
wherein tab receptors for receiving the tabs are located in the third surface wherein the tab receptors are cavities which extend only partially through the third surface.

In another exemplary embodiment of the present invention there is disclosed a method of forming an box for holding a book or object having orthogonal corners, each corner comprises:
providing a first surface having a bent ear;
providing a second surface having a fold over flap; and
forming a third surface when the fold over flap of the second surface is folded over the bottom and top edges of the bent ear;
wherein the end of the fold over flap has tabs at its end;
wherein tab receptors for receiving the tabs are located in the third surface wherein the tab receptors are cavities which extend only partially through the third surface.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows an un-folded clamshell box blank that utilizes corner designs in accordance with the principles of the invention;

FIG. 2 shows a left view of a prior art folded clamshell box in a closed position;

FIG. 3 shows a right view of a prior art folded clamshell box in a closed position;

FIG. 4 is a perspective left view of a folded clamshell box that has corners in accordance with the principles of the invention;

FIG. 5 is a perspective right view of a folded clamshell box that has corners in accordance with the principles of the invention;

FIG. 6 shows a corner section of the clamshell box of the invention partially folded;

FIG. 7 shows the corner section of the clamshell box of the invention folded to the point where tabs begin to engage cavities;

FIG. 8 shows the corner section of the clamshell box fully folded;

FIG. 9 shows the creation of a tab cavity in corrugated material;

FIG. 10 shows the creation of a tab cavity in solid core material;

FIG. 11 shows the creation of initial tab cavity in solid core material;

FIG. 12 shows the clamshell box blank of FIG. 1 folded into a box in the open position;

FIG. 13 shows the clamshell box of FIG. 12 in a half closed position; and

FIG. 14 shows the clamshell box of FIG. 12 in an almost closed position.

### DESCRIPTION OF THE PREFERRED EMBODIMENT

This invention discloses the mechanical fixation of three generally flat surfaces into a generally orthogonal corner arrangement without external fasteners or protrusions to provide a finished box with smooth interior and exterior surfaces. The three corner surfaces are defined by cut and crease lines in a generally flat sheet of bendable raw material. The sheet can have any number of cuts and creases that can be folded to create any number of smooth three dimensional corners.

A common object that could benefit from this construction method is an archival storage box for valuable books or objects. These boxes are typically made from 1/16 inch thick corrugated or solid core acid free sheet material such as cardboard.

A box that has been made for decades for receiving a book is generally referred to as having a clamshell design. The corner fixation in this clamshell design involves a fold over flap that has tabs on its end. When the flap is folded over the bent ear of a second corner surface, the tabs engage receptor holes in the third corner surface. This holds the flap and corner in their final position.

Although this corner is sturdily fixed, the tabs and tab receptor through holes produce a corner with a potentially rough exterior surface with protruding tabs. This rough surface has the potential of damaging the cover of a neighboring un-boxed book when sliding the boxed book on and off the shelf.

In this invention the tab receptors for the tabs on the end of a fold over flap are cavities which extend partially, not fully through the material, the cavities are not holes. To form the cavities the material is partially removed or pushed aside and the cavity does not go all the way through the material as is the case in the prior art clamshell box.

The smooth nature of the interior and exterior surfaces of a box utilizing this invention will allow institutions to selectively box individual books on a shelf without the need to worry about neighboring book damage.

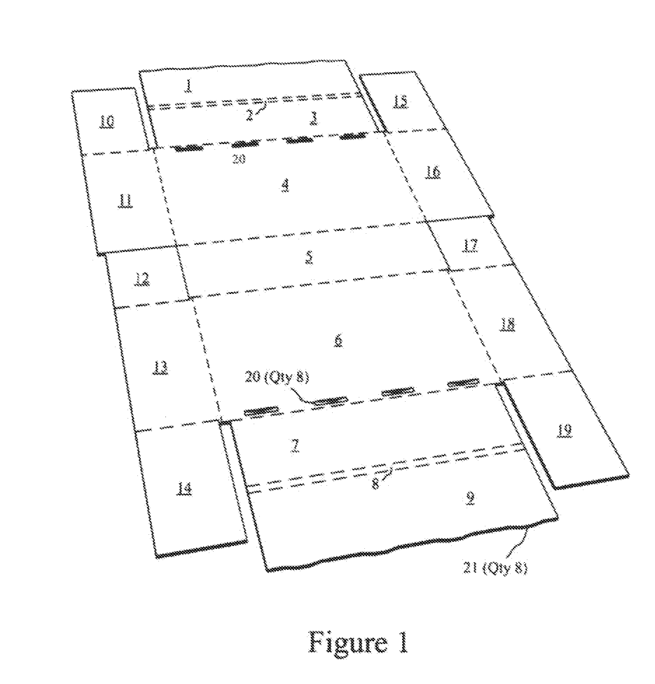

Referring to FIG. 1, there is shown shows an un-folded clamshell box blank that utilizes corner designs in accordance with the principles of the invention. Each dashed line represents a crease line and each solid line is a cut. Each flat section of the blank is labeled with reference numerals 1 through 19 and each bend line is uniquely referred to by stating the numbers of the two flat sections that border it. For example, bend line 4-5 is the bend line between sections 4 and 5.

Projections 21 (there are 8 of them in FIG. 1), are called the tabs. Cavities 20 are call the tab receptors. The number and dimensions of tabs 21 and tab receptors 20 may be optimized by experiment and are determined by the physical characteristics of the raw material that the blank is cut from and the accuracy of the cutting process itself.

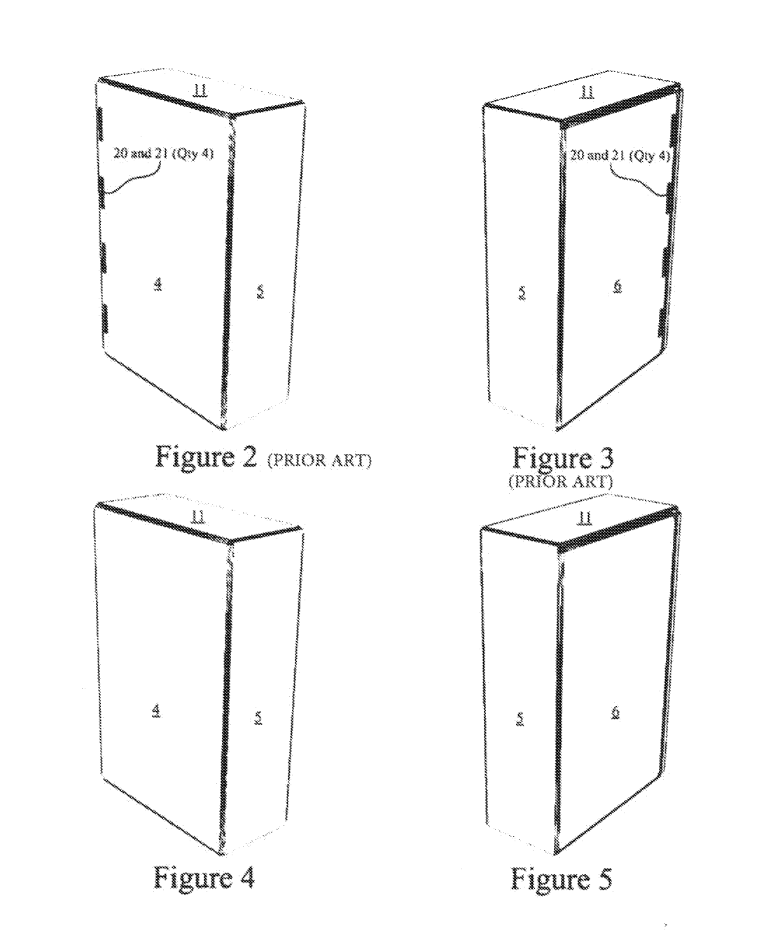

FIG. 2 shows a left view of a folded and closed prior art clamshell box, and FIG. 3 shows a right view of a folded and closed prior art clamshell box. The tab receptors 20 and tabs 21 are clearly visible on the exterior of the box in both FIG. 2 and FIG. 3.

FIG. 4 shows a left side perspective view of a folded and closed clamshell box that has corners in accordance with the principles of the invention. FIG. 5 shows a right side perspective view of a folded and closed clamshell box that has corners in accordance with the principles of the invention. There are no tab receptors or tabs which are visible or which protrude on the interior or exterior surfaces of the box in FIGS. 4 and 5.

The inventive clamshell box disclosed can be slid on and off a shelf without damaging neighboring unboxed books with protruding tabs 21 or tab receptor 20 edges.

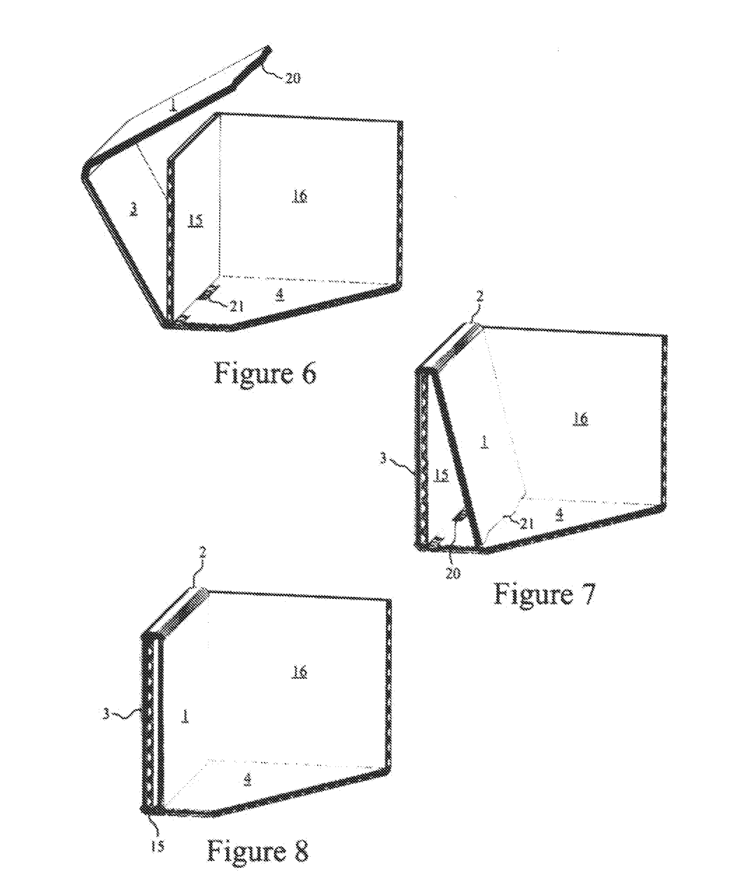

FIGS. 6, 7 and 8 show the folding progression of a three surface orthogonal corner. In the finished corner of FIG. 8, sections 1, 3 and 15 end up together as a triple thickness vertical surface which forms one of the three corner surfaces. Sections 1, 2 and 3 are called the fold over flap and they fold around the ear, Section 15, holding Section 15 in its final bent position. Sections 1 and 3 are held in their final vertical position by bend line 15-16 and the corner is stable once the tabs 21 are pushed into their tab receptors 20. It can be seen in FIG. 8 that the width across the page of Section 2 will affect the holding force of the tabs in their cavities, the greater the width, the less the holding force. The tab engagement distance is adjusted by the combined height of Sections 1 and 3. The optimum engagement distance is the full depth of the tab receptors 20.

There are many methods of creating the new tab receptor cavities and the method will vary depending on the density and structure of the raw material.

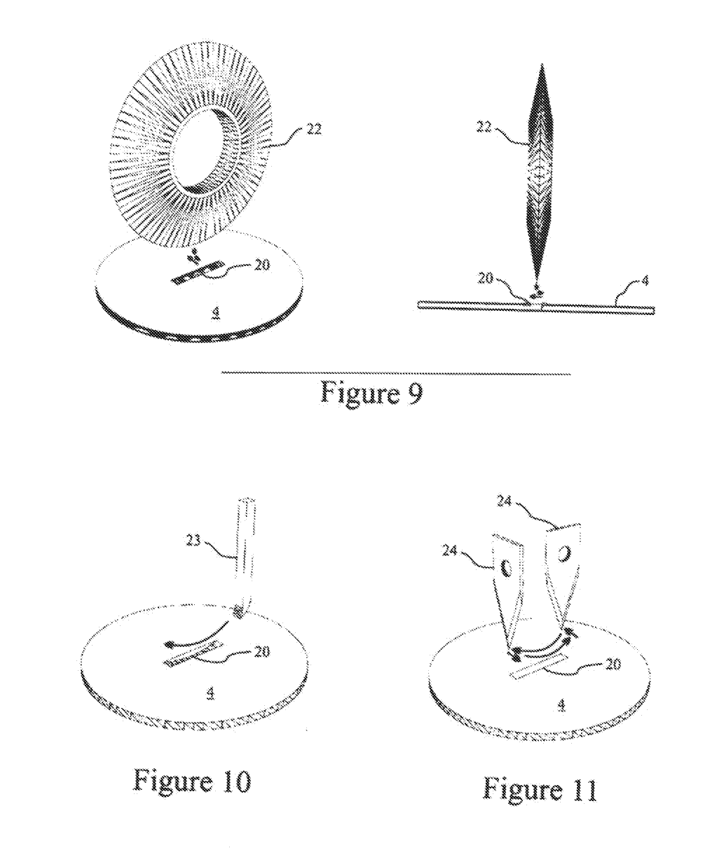

FIG. 9 depicts one method of creating the tab receptor cavities in a corrugated material. A round cutting wheel 22 may be pushed into the material to a depth which is less than its thickness. While maintaining this depth, the tool is moved sideways about one half the desired cavity width. This pushes the material aside where it generally remains when the tool is removed. To finish the cavity, the tool is moved sideways in the other direction for the whole width of the desired cavity. This pushes the other half of the material out of the cavity. To ensure that the material remains pushed aside, the tool may be move sideways, back and forth across the cavity one or more times. Excess material also creates a small bump on the edges of the cavity.

FIG. 10 depicts one method of creating the tab receptor cavities in a generally solid core material. A special chisel type tool (23) can be created that simply scoops out the cavities in one motion. If this scooping motion leaves the edges of the cavity too ragged, a slicing knife can be used to pre-cut the edges of the cavity prior to chiseling out the material. This pre-cut is depicted in FIG. 11 using the slicing knife 24.

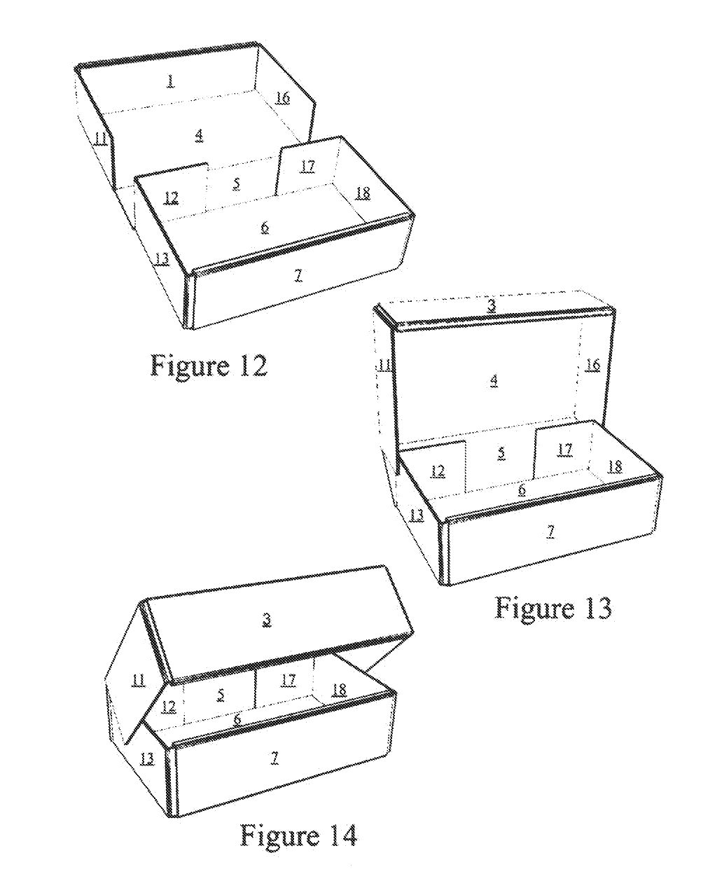

FIG. 12 shows the clamshell box blank of FIG. 1 folded into a box in the open position. FIG. 13 shows the clamshell box of FIG. 12 in a half closed position, and FIG. 14 shows the clamshell box of FIG. 12 in an almost closed position.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. A storage box for holding a book or object having orthogonal corners, each corner comprising:
a first surface having a bent ear;
a second surface having a fold over flap; and
a third surface that is formed when the fold over flap of the second surface is folded over the bottom and top edges of the bent ear;
wherein the end of the fold over flap has tabs at its end;
wherein tab receptors for receiving the tabs are located in the third surface wherein the tab receptors are cavities which extend only partially through the third surface.

2. The box of claim 1 wherein there are no tabs or tab receptors visible on the interior and exterior surfaced of each corner.

3. The box of claim 2 wherein the width of the fold over flap around the top of the bent ear affects the holding force of the tabs in their cavities.

4. The box of claim 3 wherein the greater the width of the fold over flap the less the holding force.

5. The box of claim 2 wherein the tab engagement distance is determined by the combined length of the fold over flap along each side of the bent ear.

6. The box of claim 2 wherein the tab engagement distance is adjusted by the combined length of the fold over flap along each side of the bent ear.

7. The box of claim 2 wherein the optimal tab engagement distance is the full depth of the tab receptors.

8. The box of claim 2 wherein the box is made of a corrugated material.

9. The box of claim 2 wherein the box is made of a solid core material.

10. A method of forming an box for holding a book or object having orthogonal corners, each corner comprises:
providing a first surface having a bent ear;
providing a second surface having a fold over flap; and
forming a third surface when the fold over flap of the second surface is folded over the bottom and top edges of the bent ear;
wherein the end of the fold over flap has tabs at its end;
wherein tab receptors for receiving the tabs are located in the third surface wherein the tab receptors are cavities which extend only partially through the third surface.

11. The method of forming the box of claim 10 wherein there are no tabs or tab receptors visible on the interior and exterior surfaced of each corner.

12. The method of forming the box of claim 11 wherein the width of the fold over flap around the top of the bent ear affects the holding force of the tabs in their cavities.

13. The method of forming the box of claim 12 wherein the greater the width of the fold over flap the less the holding force.

14. The method of forming the box of claim 11 wherein the tab engagement distance is determined by the combined length of the fold over flap along each side of the bent ear.

15. The method of forming the box of claim 11 wherein the tab engagement distance is adjusted by the combined length of the fold over flap along each side of the bent ear.

16. The method of forming the box of claim 11 wherein the optimal tab engagement distance is the full depth of the tab receptors.

17. The method of forming the box of claim 11 wherein the box is made of a corrugated material.

18. The method of forming the box of claim 11 wherein the box is made of a solid core material.
